(19) United States
(12) Patent Application Publication
(10) Pub. No.: US 2016/0029539 A1
(43) Pub. Date: Feb. 4, 2016

(54) Detachable Transportable Rock Picker

(71) Applicant: Mark Aho, New Ipswich, NH (US)

(72) Inventor: Mark Aho, New Ipswich, NH (US)

(21) Appl. No.: 14/056,947

(22) Filed: Oct. 18, 2013

(51) Int. Cl. A01B 43/00

(52) U.S. Cl. CPC A01B 43/005

(57) ABSTRACT

A rock picker towing apparatus attachable by mounting to a prime mover end (power unit) includes a front and rear elevator transfer apparatus; a tromell separator; dump trailer detachably connectable to the tromell unit frame; a hydraulic power supply unit in fluid communication with the tromell unit and transfer apparatus.

### RELATED U.S. PATENT DOCUMENTS

References Cited
U.S. Patent Documents

| | | |
|---|---|---|
| 19,430 | February 1858 | Maydole |
| 47,566 | May 1865 | Quimby |
| 624,852 | May 1899 | Nugent |
| 946,115 | January 1910 | Edens |
| 946,273 | January 1910 | Richards |
| 1,478,142 | December 1923 | Ortmann |
| 1,563,340 | December 1925 | Christenson |
| 2,363,682 | November 1944 | Madsen et al. |
| 2,686,394 | August 1954 | Kalaus et al. |
| 2,725,700 | December 1955 | Fahrenholz |
| 2,924,284 | February 1960 | Cykler et al. |
| 3,117,631 | January 1964 | Fehrenholz |
| 3,261,408 | July 1966 | Simonar |
| 3,431,979 | March 1969 | Gregerson |
| 3,739,855 | June 1973 | Bliss |
| 3,782,477 | January 1974 | Farenholz |
| 4,040,489 | August 1977 | Hulicsko |
| 4,059,158 | November 1977 | Ranger |
| 4,153,114 | May 1979 | Morlock |
| 4,221,265 | September 1980 | Pratt |
| 4,282,932 | August 1981 | Anderson |
| 4,296,818 | October 1981 | Malinowski et al. |
| 4,301,869 | November 1981 | Dubois |
| 4,319,641 | March 1982 | Degelman |
| 4,345,655 | August 1982 | Farenholz |
| 4,609,049 | September 1986 | Migdal |
| 4,609,050 | September 1986 | Jacobs et al. |
| 4,878,802 | November 1989 | Hansen et al. |
| 5,027,906 | July 1991 | Jeannotte et al. |
| 5,310,008 | May 1994 | Dauvin |
| 6,041,866 | March 2000 | Smith |
| 6,702,034 | March 2004 | Clary |
| 7,028,460 | April 2006 | Fahrenholz |
| 7,658,233 | February 2010 | Aho |

### FIELD OF THE INVENTION

The present invention relates to a rock picker system. More particularly, the present invention relates to an improved, detachable, collapsible and transportable rock picker with a built in tromell unit and dump bucket.

### BACKGROUND OF THE INVENTION

The need to remove rocks from debris and rock filled fields has been a pressing demand as far as we can recall. Rocks and/or hard materials can break the plow blades and/or become jammed in the moving equipment causing critical damage.

Existing rock picker apparatus are non-modular and are generally very expensive to purchase as well as maintain. Due to variances in object sizes, components may get lodged causing vulnerability to jamming. Additionally, existing systems are only able to pick up rocs in the 4 to 8 inch depth range where this said invention accommodates 2-18 inches. Existing apparatus have focused on integrating the rock picker within the actual prime mover causing issues with both upkeep and maintenance. Current Apparatus on the market require mechanical linkages and gearing systems which are difficult to maintain. All of these shortcomings severely impact efficiency and increase the risk of costly repairs.

Thus, there is a need for a detachable rock picker system that:

1) is modular 2) is capable of extracting, storing and dumping a large volume of rock from a field with a high rate of efficiency; 3) non lodging/jamming components 4) rear mounted for easy attachment to primary mover. 5) includes windrow rakes attached front and rear elevator for efficient collection of rock materials 6) does not require complex customized mechanical linkages and gear systems; 14) modularity permits components to be changed to different size or style.

A number of devices have provided rock pickers, but lack easy functionality, reliability, affordability and lower maintenance upkeep of the present invention. Presently known art attempts to address this problem, but has not completely solved the problem. The following represents a list of know related art:

TABLE-US-00001 Reference: Issued to: Date of Issue: U.S. Pat. No. 7,658,233 Feb. 9 2010 U.S. Pat. No. 7,028,460 B1 Fahrenholz Apr. 18, 2006 U.S. Pat. No. 4,345,655 Fahrenholz Aug. 24, 1982 U.S. Pat. No. 3,782,477 Fahrenholz Jan. 1, 1974 U.S. Pat. No. 3,117,631 Fahrenholz Jan. 14, 1964 U.S. Pat. No. 2,725,700 Fahrenholz Dec. 6, 1955 U.S. Pat. No. 6,702,034 B2 Clary Mar. 9, 2004 U.S. Pat. No. 6,041,866 Smith Mar. 28, 2000 U.S. Pat. No. 5,310,008 Dauvin May 10, 1994 U.S. Pat. No. 5,027,906 Jeannotte et al Jul. 2, 1991 U.S. Pat. No. 4,609,050 Jacobs et al Sep. 2, 1986 U.S. Pat. No. 4,609,049 Migdal Sep. 2, 1986 U.S. Pat. No. 4,319,641 Degelman Mar. 16, 1982 U.S. Pat. No. 4,301,869 Dubois Nov. 24, 1981 U.S. Pat. No. 4,296,818 Malinowski et al Oct. 27, 1981 U.S. Pat. No. 4,282,932 Anderson Aug. 11, 1981 U.S. Pat. No. 4,221,265 Pratt Sep. 9, 1980 U.S. Pat. No. 4,153,114 Morlock May 8, 1979 U.S. Pat. No. 4,059,158 Ranger Nov. 22, 1977 U.S. Pat. No. 4,040,489 Hulicsko Aug. 9, 1977 U.S. Pat. No. 3,739,855 Bliss Jun. 19, 1973 U.S. Pat. No. 3,431,979 Gregerson Mar. 11, 1969 U.S. Pat. No. 3,261,408 Simonar Jul. 19, 1966 U.S. Pat. No. 2,924,284 Cykler et al Feb. 9, 1960 U.S. Pat. No. 2,686,394 Kalaus et al Aug. 17, 1954 U.S. Pat. No. 2,363,682 Madsen et al Nov. 28, 1944 U.S. Pat. No. 1,563,340 Christenson Dec. 1, 1925 U.S. Pat. No. 1,478,142 Ortmann Dec. 18, 1923 U.S. Pat. No. 946,115 Edens Jan. 11, 1910 U.S. Pat. No. 946,273 Richards Jan. 11, 1910 U.S. Pat. No. 624,852 Nugent May 9, 1899 U.S. Pat. No. 047,566 Quimby May 2, 1865 U.S. Pat. No. 019,430 Maydole Feb. 23, U.S. Pat. No 7658233 Aho Feb

None of the above inventions and patents, taken either singularly or in combination, is seen to describe the invention as claimed.

Fahrenholz in several patents teaches rock picker systems: U.S. Pat. No. 7,028,460 B1 (the Fahrenholz '460 patent); U.S. Pat. No. 4,345,655 (the Fahrenholz '655 patent); U.S. Pat. No. 3,782,477 (the Fahrenholz '477 patent); U.S. Pat. No. 3,117,631 (the Fahrenholz '631 patent); U.S. Pat. No. 2,725,700 (the Fahrenholz '700 patent).

The Fahrenholz patents encompass similarities utilizing windrows, drum separators, storage component but uses complicated conveyor systems which our invention doesn't. Fahrenholz system is not structured to efficiently capture material as this invention does. The use of the windrow rakes to guide material towards the lower elevator increases surface usage. The lower elevator allows material to move upward towards the hydraulic driven tromell separator. Tromell separator will move larger rocks and boulders to upper elevator to dump trailer.

### SUMMARY AND ADVANTAGES OF THE INVENTION

A rock picker towing apparatus attachable by mounting to a prime mover end (power unit) includes a front and rear elevator transfer apparatus; a tromell separator; dump trailer detachably connectable to the tromell unit frame; an hydraulic power supply unit in fluid communication with the tromell unit and transfer apparatus. Windrow rake apparatus mounted to and extending forward from said tromell unit frame, for agitating soil and causing rocky soil towards move toward centrally mounted front elevator; said collector means mounted to said prime mover for collecting said rocky soil from said windrow means and moving said rocky soil towards tromell separator; said separator means mounted to said tromell unit for receiving said rocky soil from said collector means and separating rocks from said rocky soil and moving said rocks to front elevator; said front elevator and tromell separator mounted on tromell unit frame transferring said rocks to rear elevator; said rear elevator mounted to dump trailer unit; means dump trailer receiving and storing rocks from said transfer means, transporting said rocks to an offloading location, and offloading said rocks; an hydraulic power supply mounted to said rock picker, said hydraulic power supply in fluid communication with tromell unit.

The rock picker system of the present invention presents numerous advantages, including: 1) is modular and augment to current tools 2) is capable of extracting, storing and dumping a large volume of rock from a field with a high rate of efficiency 3) non lodging/jamming components 4) rear mounted for easy attachment to primary mover 5) includes windrow rakes attached front and rear elevator for efficient collection of rock material 6) does not require complex customized mechanical linkages and gear systems 14) modularity permits components to be changed to different size or style.

### BRIEF DESCRIPTION OF THE SEVERAL VIEWS OF THE DRAWINGS

The accompanying drawings, which are incorporated into and constitute a part of this specification, illustrate one or more embodiments of the present invention and, together with the detailed description, serve to explain the principles and implementations of the invention.

FIG. 1 shows the front view of the rock picker system detached from the prime mover.

FIG. 2 shows a detail view of windrow rake apparatus mounted to and extending forward.

FIG. 3 shows a front view of the front elevator transfer apparatus.

FIG. 3a shows a perspective view of the front elevator transfer apparatus.

FIG. 4 shows a rear view of the tromell separator unit.

FIG. 4a shows a perspective view of the tromell separator unit affixed to the tromell unit frame.

FIG. 5 shows a rear view of the rear elevator.

FIG. 5a shows a perspective view of the rear elevator.

FIG. 6 shows a side view of a rock picker system mounted to a prime mover including a dump trailer (8) and how agitated soil is process through the said invention.

FIG. 7 shows a rear view of the dump trailer its depressed dumping position

FIG. 8 shows a perspective view of a dump trailer;

FIG. 8a shows a perspective view of a dump trailer;

FIG. 8b shows a perspective view of a dump trailer.

FIG. 9 shows a top view of a rock picker system how agitated soil is process through the said invention.

FIG. 10 shows a perspective view of the said invention and how agitated soil is process through the said invention.

### DETAILED DESCRIPTION

Reference Numbers used in Drawings

The following list of reference numbers used in the drawings is provided for convenience:

WINDROW HARLEY RAKE APPARATUS 1 WHEELS 2 TOW HITCH 3 POWER TAKEOFF SHAFT 4 FRONT ELEVATOR 5 FRONT SUPPORT STRUCTURE 6 TROMELL UNIT 7 TRAILER BIN 8 REAR ELEVATOR 9 HYDRAULIC POWER UNIT 10 TRAILER FRAME 11 TROMELL UNIT FRAME 12 HYDRAULIC UNIT SHAFT

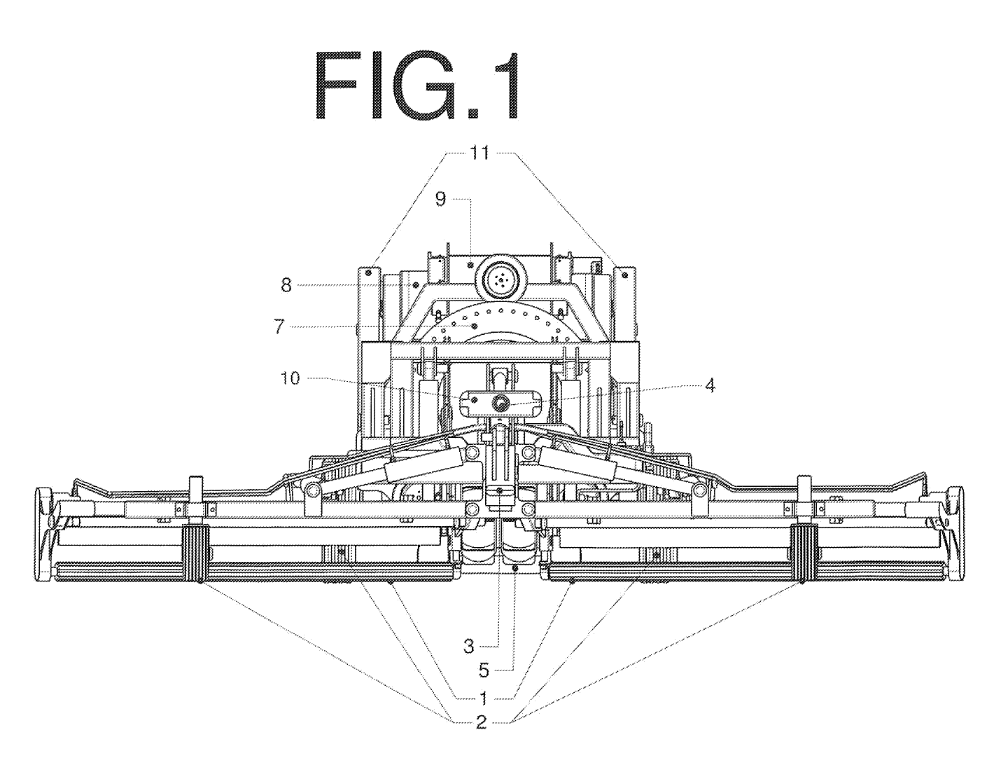

Referring to FIGS. 1-10, A rock picker towing apparatus attachable by mounting to a prime mover end (power unit) includes a front and rear elevator transfer apparatus; a tromell separator; dump trailer detachably connectable to the tromell unit frame; an hydraulic power supply unit in fluid communication with the tromell unit. Windrow rake apparatus mounted to and extending forward from said tromell unit frame, for agitating soil and causing rocky soil towards move toward centrally mounted front elevator; said collector means mounted to said prime mover for collecting said rocky soil from said windrow means and moving said rocky soil towards tromell separator; said separator means mounted to said tromell unit for receiving said rocky soil from said collector means and separating rocks from said rocky soil and moving said rocks to front elevator; said front elevator mounted to tromell unit separator and transferring said rocks to rear elevator; said rear elevator mounted to dump trailer unit bin; means dump trailer bin receiving and storing rocks from said transfer means, transporting said rocks to an offloading location, and offloading said rocks; an hydraulic power supply mounted to said rock picker, said hydraulic power supply in fluid communication with tromell unit.

FIG. 1 shows the front view of the picker system detached from the prime mover. Tow hitch (2) is attached to primary mover end. Windrow rake apparatus (1) mounted to and extending forward from said tromell unit frame (12) for agitating soil and causing rocky soil towards move toward centrally mounted front elevator (5) affixed to trailer frame (11).

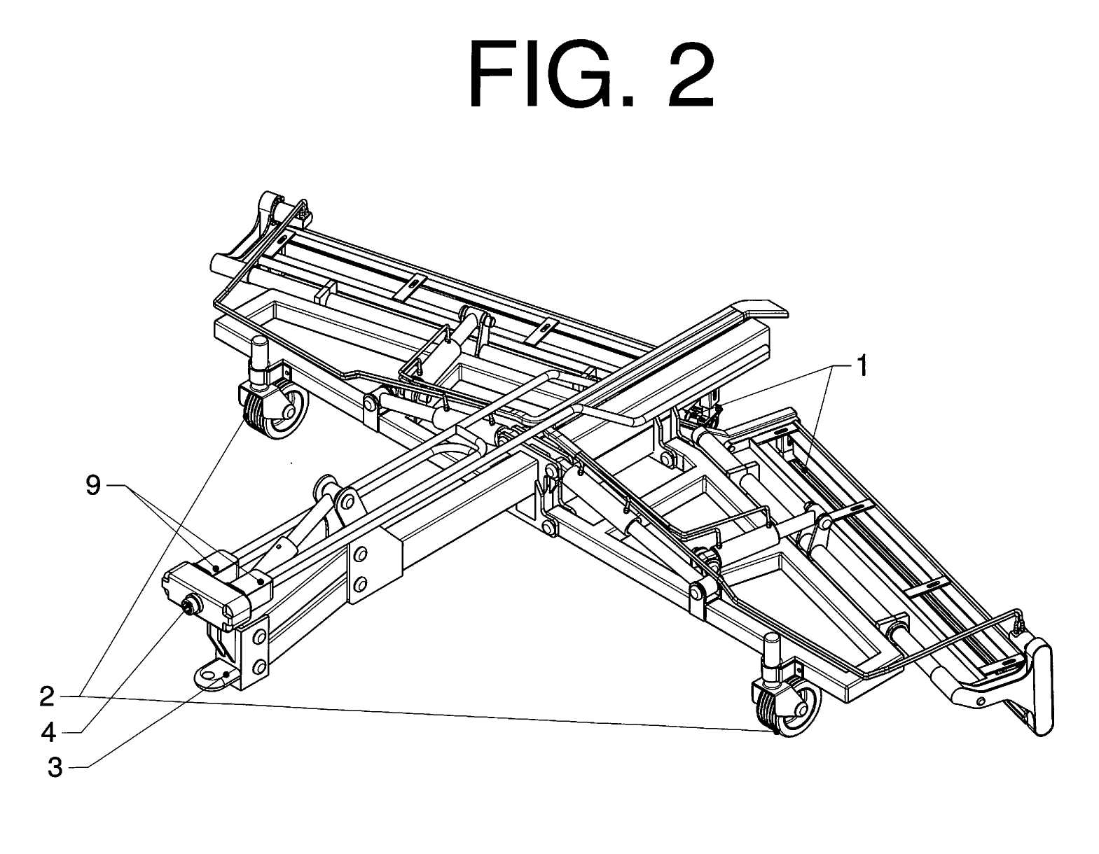

FIG. 2 shows a detail view of windrow rake apparatus (1) mounted to and extending forward. Agitated soil moves towards centrally mounted front elevator (5) to tromell separator (6) affixed to tromell unit frame (12).

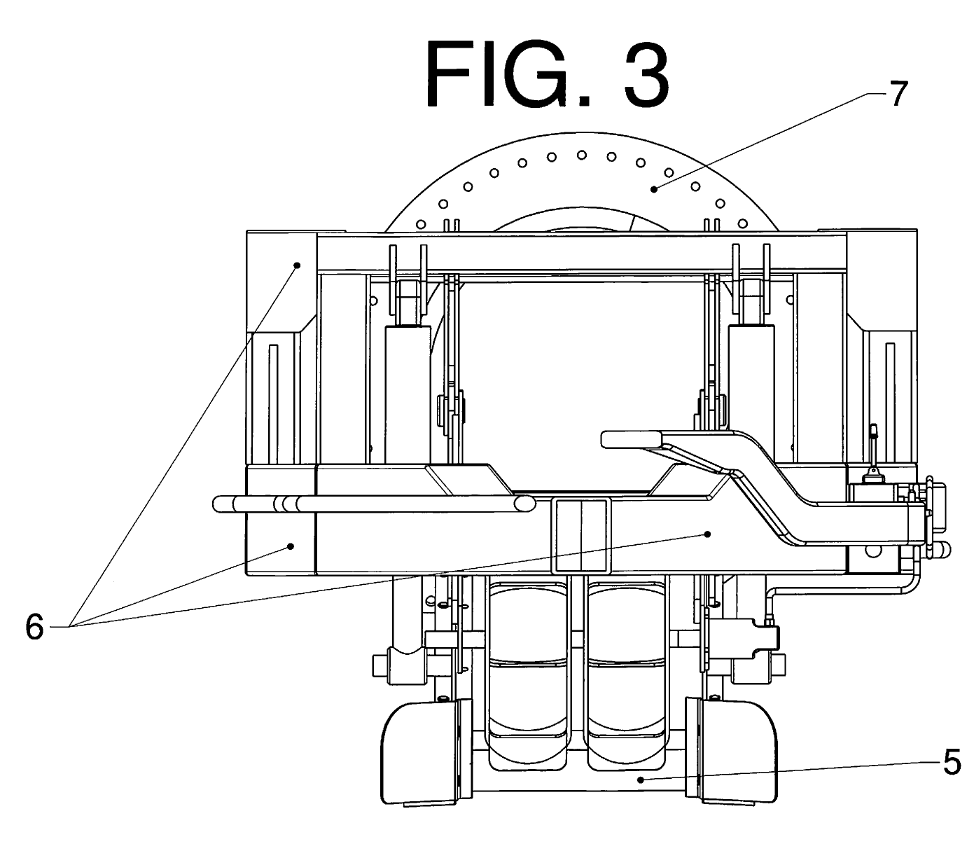

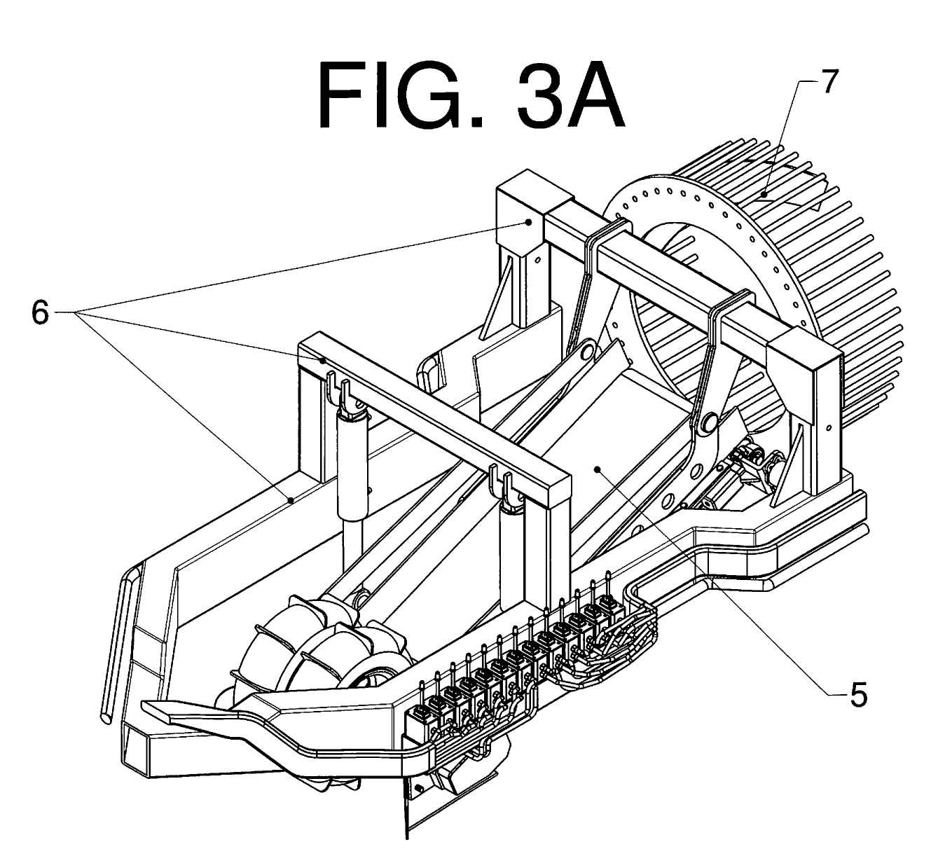

FIG. 3 shows a front view of the front elevator transfer apparatus (5) which receives agitated soil from outlet end of the windrow rake apparatus unit (1) affixed to the tromell unit frame (12).

FIG. 3a shows a perspective view of the front elevator transfer apparatus (5) which receives agitated soil from outlet end of the windrow rake apparatus unit (1) affixed to the tromell unit frame (12).

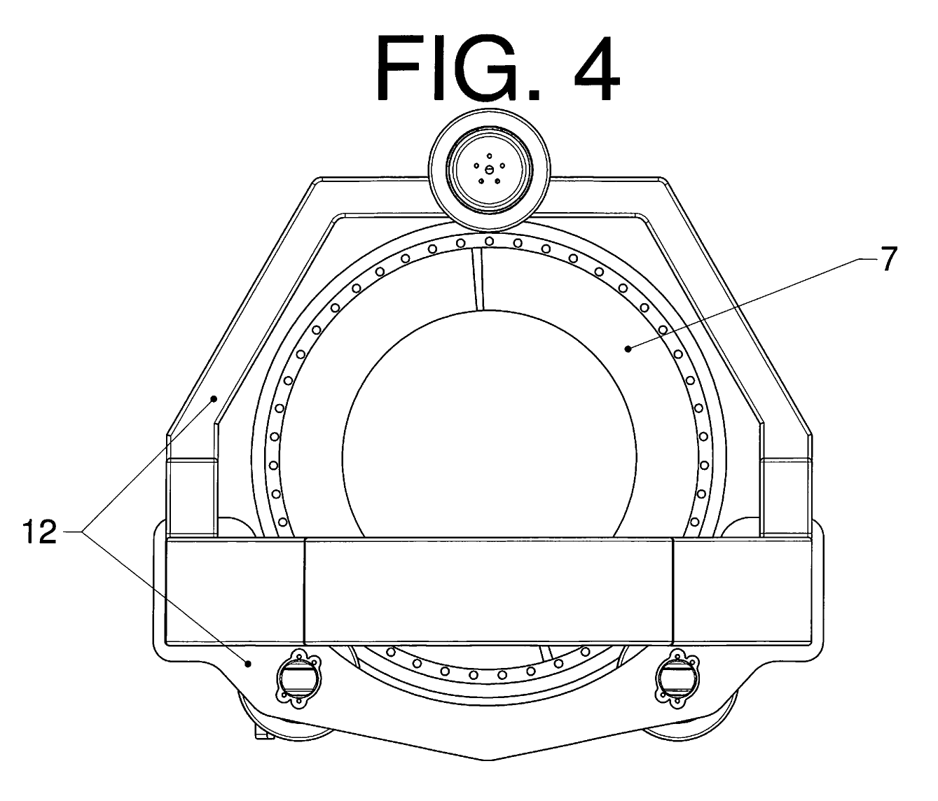

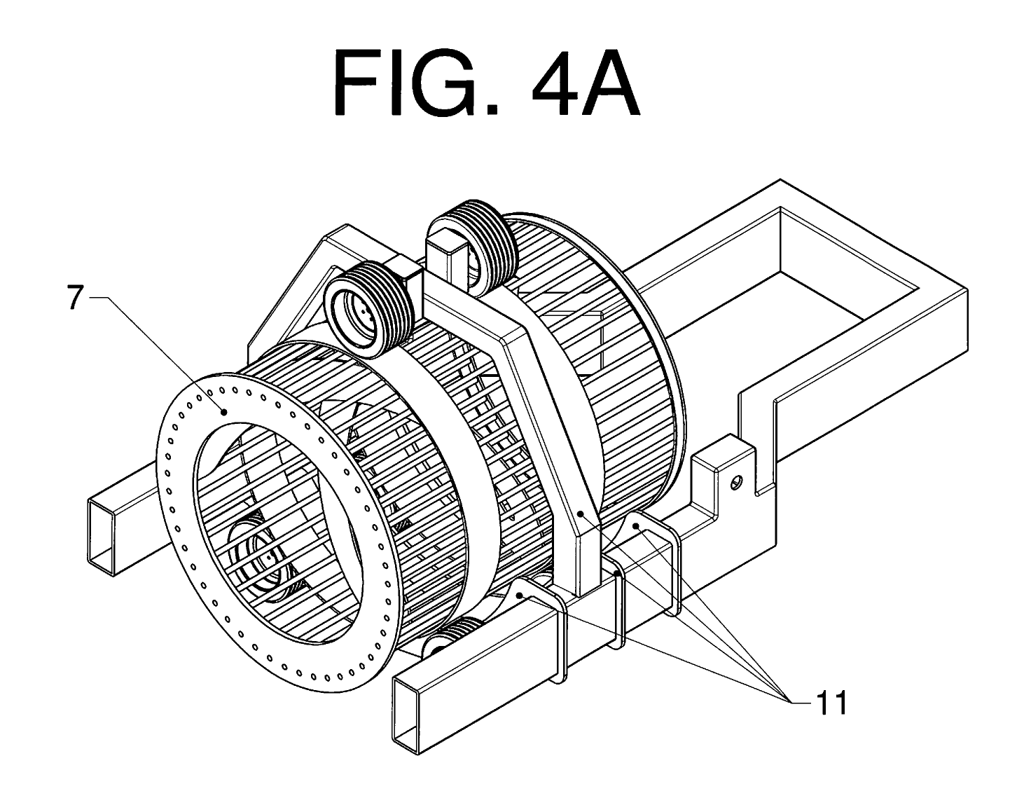

FIG. 4 shows a rear view of the tromell separator unit (6) affixed to the tromell unit frame (12). Agitated soil is transferred from the front elevator transfer apparatus (1) to the tromell separator unit (6). The cylindrical trammel separator (6) rotates as suggested by the hydraulic power supply unit (10) which separate materials by size or as preferred. Incorporation of customized screens will increase further filtering to desired results.

FIG. 4a shows a perspective view of the tromell separator unit (6) affixed to the tromell unit frame (12). Agitated soil is transferred from the front elevator transfer apparatus (1) to the tromell separator unit (6). The cylindrical trammel separator (6) rotates as suggested by the hydraulic power supply unit (10) which separate materials by size or as preferred. Incorporation of customized screens will increase further filtering to desired results.

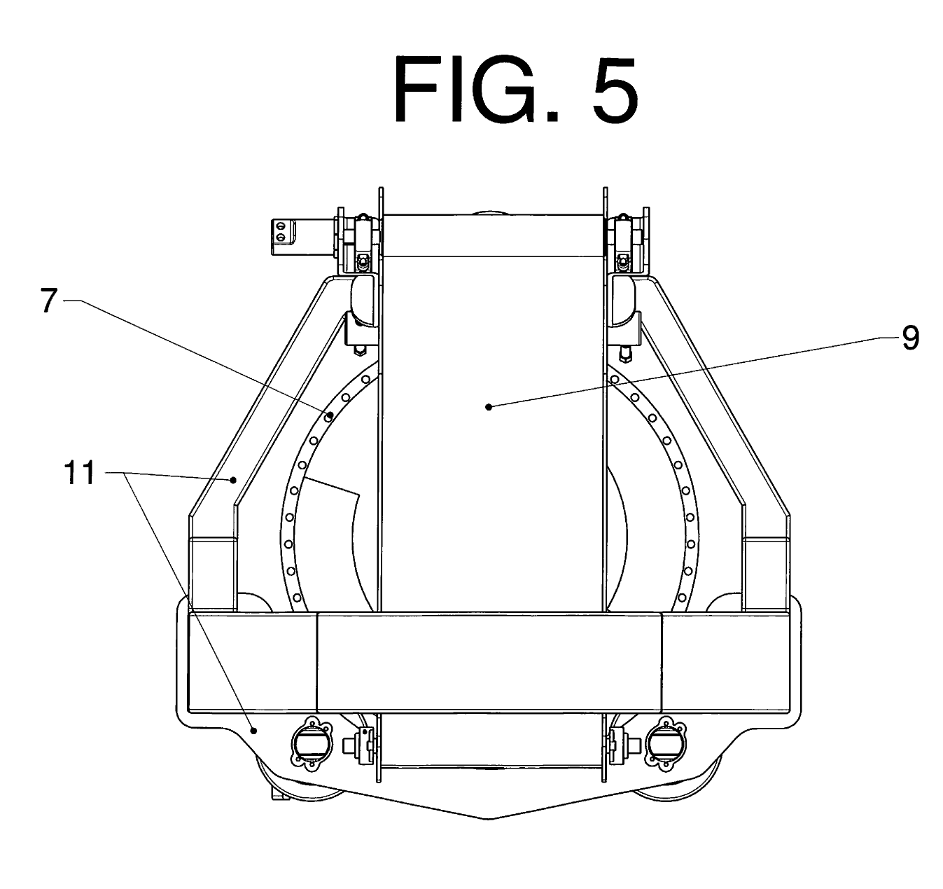

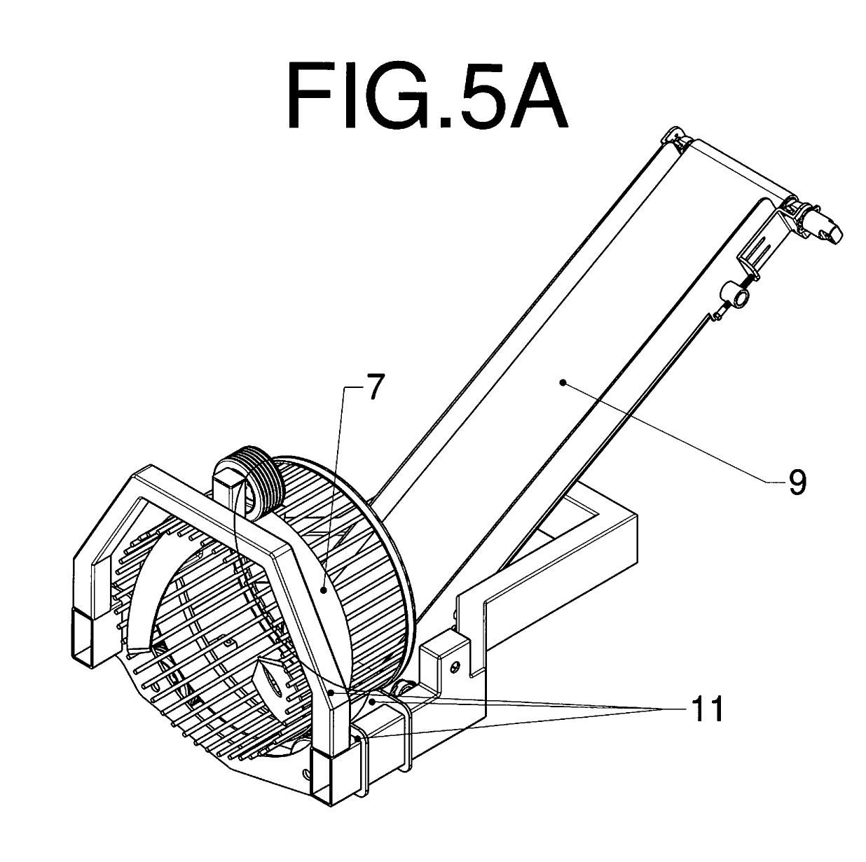

FIG. 5 shows a rear view of the rear elevator. Transferring said rocks through the tromell separator (6) to said rear elevator (9) mounted to dump trailer unit (8).

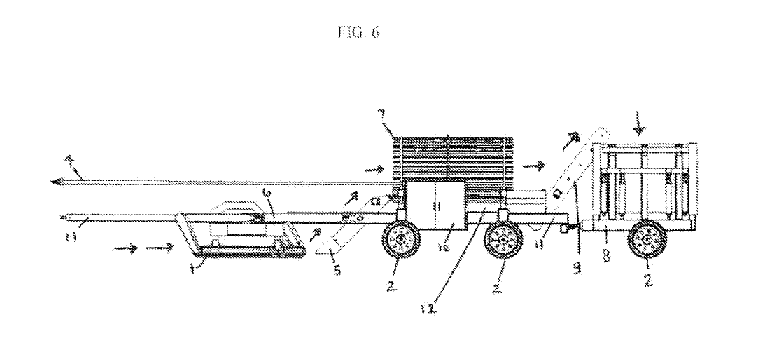

FIG. 5a shows a perspective view of the rear elevator. Transferring said rocks through the tromell separator (6) to said rear elevator (9) mounted to dump trailer unit (8) FIG. 6 shows a side view of a rock picker system mounted to a prime mover including a dump trailer (8) and how agitated soil is process through the said invention. As recapped above; A rock picker towing apparatus attachable by mounting to a prime mover end (power unit) includes a front (5) and rear (9) elevator transfer apparatus; a tromell separator (6); dump trailer detachably connectable to the tromell unit frame (12); an hydraulic power supply unit (10) in fluid communication with the tromell unit. Windrow rake apparatus (1) mounted to and extending forward from said tromell unit frame (12), for agitating soil and causing rocky soil towards move toward centrally mounted front elevator (5); said collector means mounted to said prime mover for collecting said rocky soil from said windrow (1) means and moving said rocky soil towards tromell unit separator (7); said separator means mounted to said tromell unit (7) for receiving said rocky soil from said collector means and separating rocks from said rocky soil and moving said rocks to front elevator (5); said front elevator (5) mounted to tromell separator (7) and transferring said rocks to rear elevator (9); said rear elevator (9) mounted to dump trailer unit bin; means dump trailer receiving and storing rocks from said transfer means, transporting said rocks to an offloading location, and offloading said rocks; an hydraulic power supply mounted (10)to said rock picker, said hydraulic power supply (10) in fluid communication with tromell unit (7) via hydraulic unit shaft (11).

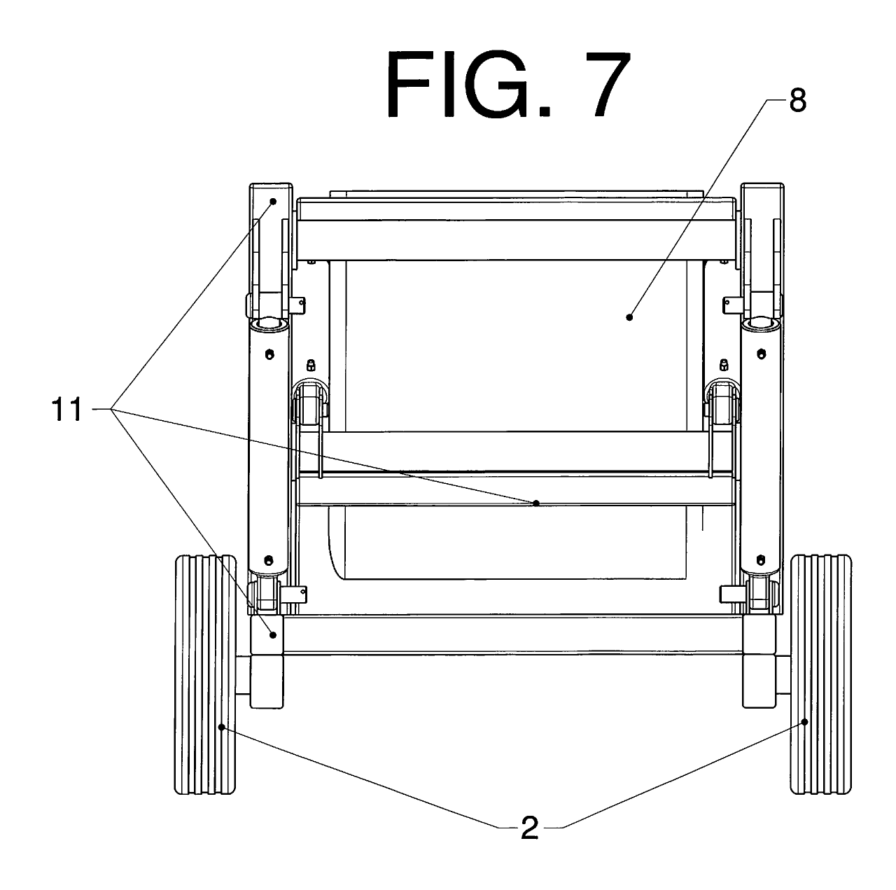

FIG. 7 shows a rear view of the dump trailer its depressed dumping position; Receiving and storing rocks from said transfer means, transporting said rocks to an offloading location, and offloading said rocks.

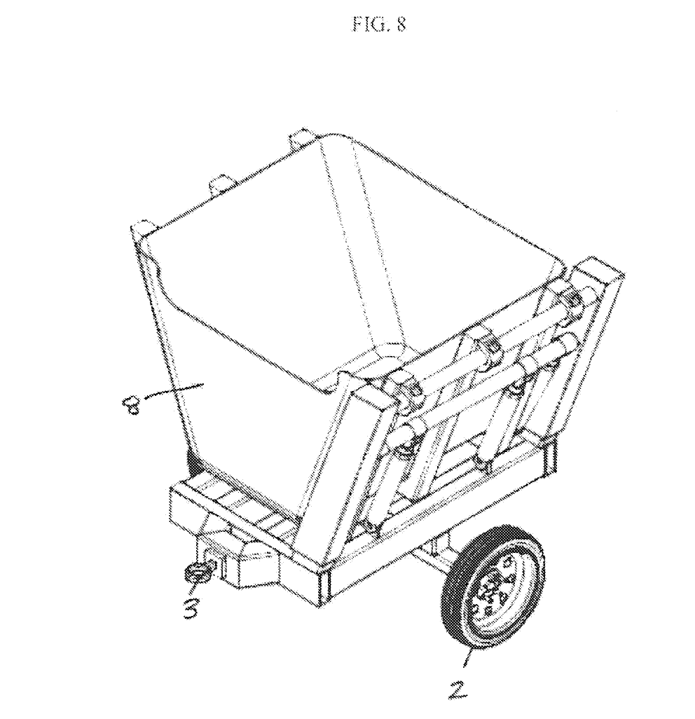

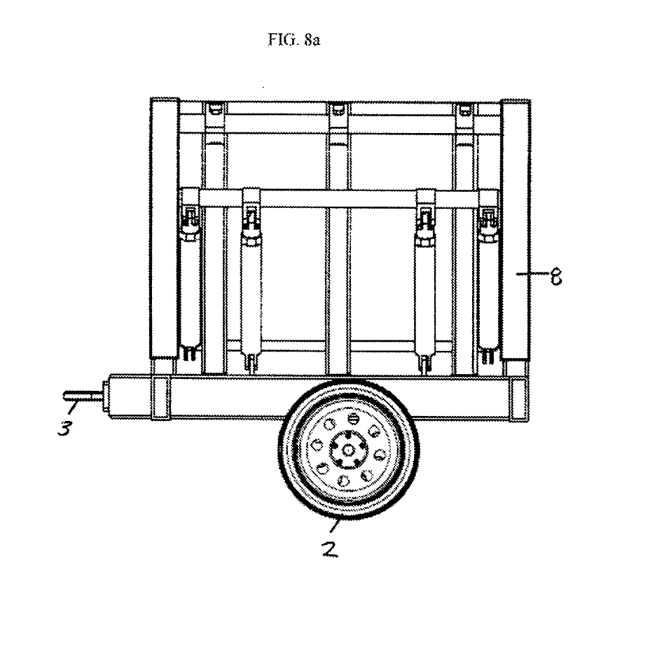

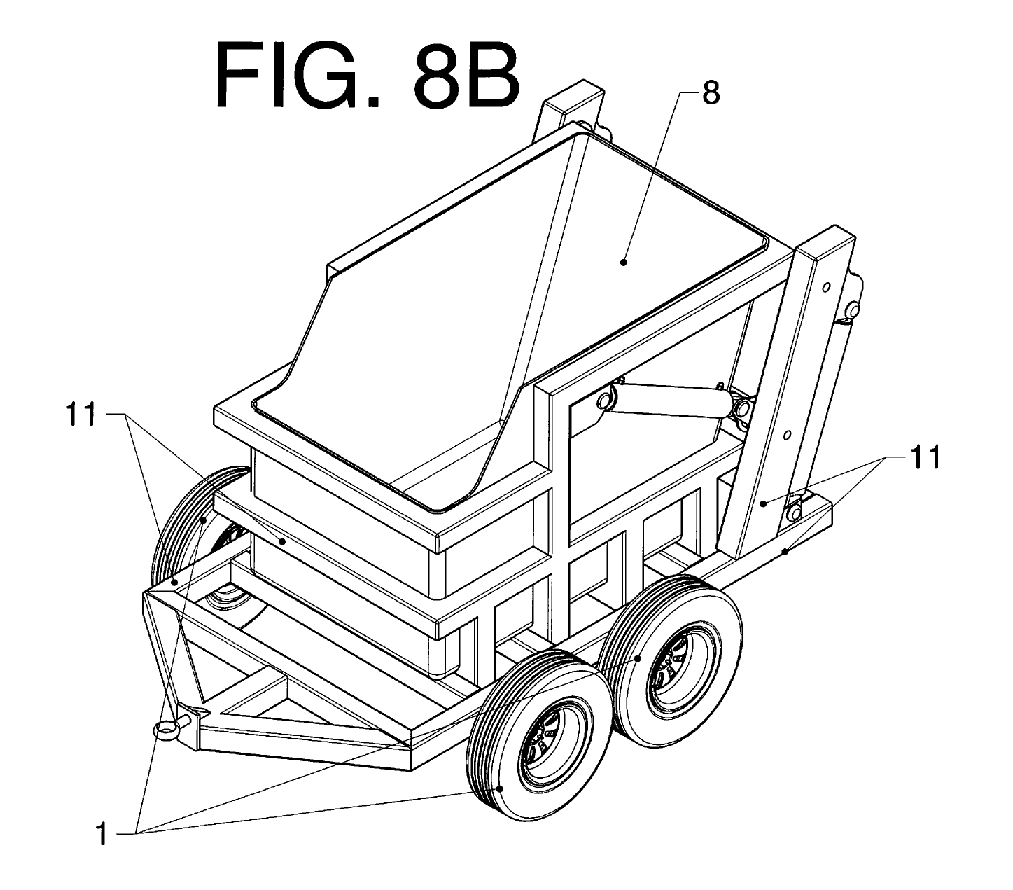

FIG. 8b shows a perspective view of a dump trailer. Receiving and storing rocks from said transfer means, transporting said rocks to an offloading location, and offloading said rocks.

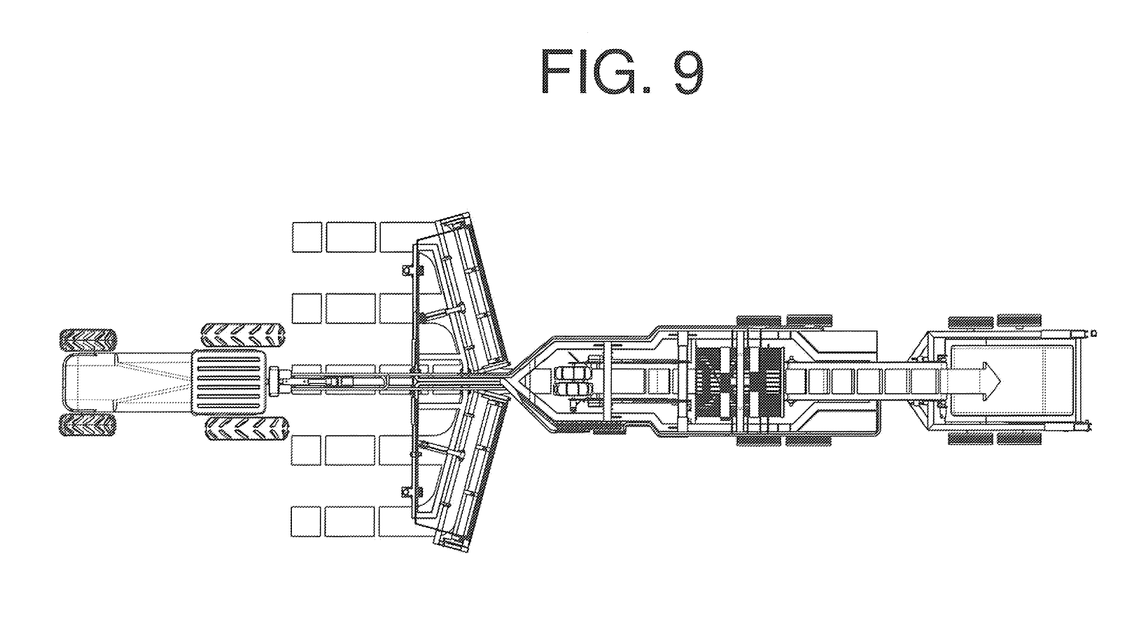

FIG. 9 shows a top view of a rock picker system how agitated soil is process through the said invention.

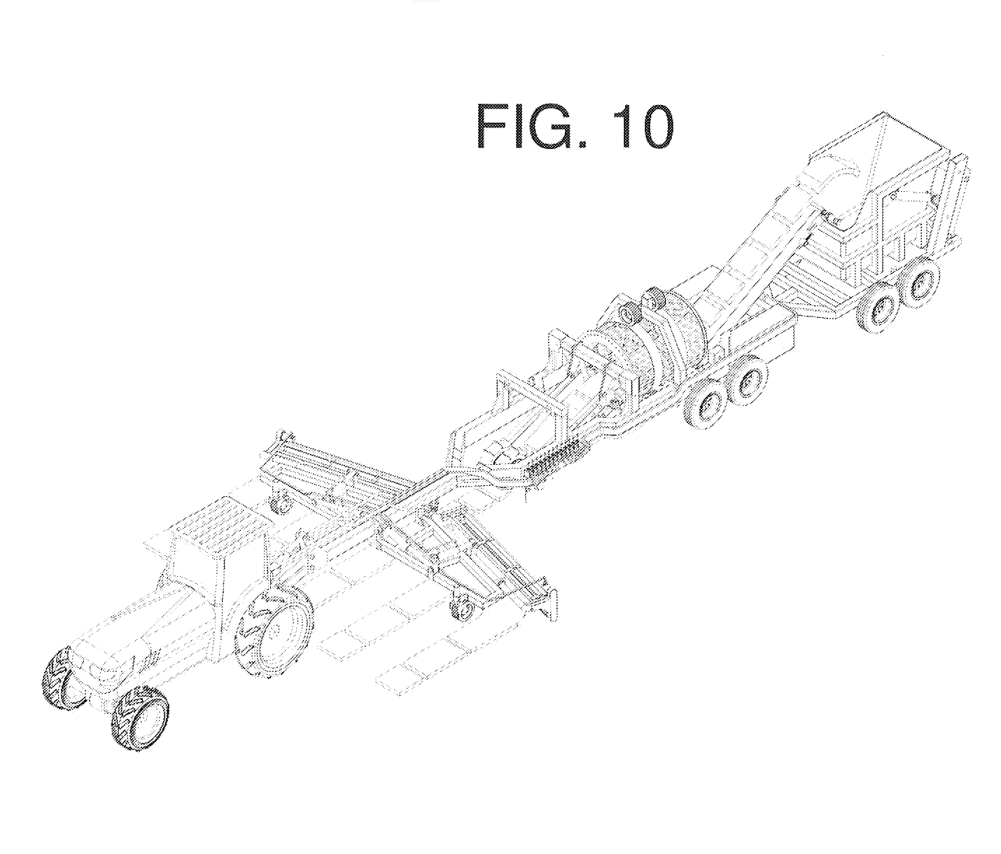

FIG. 10 shows a perspective view of the said invention and how agitated soil is process through the said invention.

I claim:

1. A rock picker towing apparatus attachable by mounting a prime mover end (power unit) includes a front and rear elevator transfer apparatus; a tromell separator; dump trailer detachable connectable to the tromell unit frame; an hydraulic power supply unit in fluid communication with the tromell unit and a transfer apparatus. Windrow rake apparatus mounted to and extending forward from said tromell unit frame, for agitating soil and causing rocky soil towards move toward centrally mounted front elevator; said front elevator means mounted to said prime mover for collecting said rocky soil from said windrow means and moving said rocky soil towards tromell separator; said separator means mounted to said tromell unit for receiving said rocky soil from said collector means and separating rocks from said rocky soil and moving said rocks to front elevator; said rocks to rear elevator; said rear elevator mounted to dump trailer unit; means dump trailer receiving and storing rocks from said transfer means, transporting said rocks to an offloading location, and offloading said rocks; an hydraulic power supply mounted to said rock picker, said hydraulic power supply in fluid communication via hydraulic unit shaft

2. The rock picker system of claim 1, wherein said control means includes: an operational hydraulic unit shaft, wherein said shaft corresponds to said tromell unit; wherein said control is manually operated by power take off valve

3. The rock picker system of claim 1, wherein said windrow means comprises a windrow assembly extending forward of said prime mover, said windrow assembly comprising: a forward front support Y frame structure attachable to front support tromell unit frame, transfer means, and dump trailer mean

4. The rock picker of claim 3, wherein said left and right windrow agitate desired soil causing rocky soil towards move toward centrally mounted front elevator

5. The rock picker of claim 4, wherein said front support frame includes at least four road wheels

6. The rock picker of claim 1, wherein said collector means comprises: a front elevator connected to the trailer frame and aligned longitudinally to the inlet for the tromell unit, a tromell unit mounted at the end of the front elevator to separate rocks and boulders from agitated soil; and, a hydraulic unit shaft in fluid communication with said hydraulic power unit distribution means powered by power take off-shaft. Tromell feeds rocks into rear elevator to trailer bin

7. The rock picker of claim 1, wherein said separator means comprises: a tromell separator including an hydraulic drive shaft in fluid communication with said hydraulic power distribution means, said tromell longitudinally on said prime mover so as to receive rocky soil from said collector means and discharge rocks to said transfer means, wherein said tromell moves larger material to rear elevator

8. The rock picker of claim 1, wherein said transfer means comprises: a front elevator connected to said front support structure, said front elevator including: an hydraulic shaft in fluid communication with said hydraulic power distribution means, pivoting means in fluid communication with said hydraulic power distribution means for activating said tromell. Front elevator raises ground level material to tromell. Tromell rotates unloading material to said rear elevator to said trailer means

9. The rock picker of claim 1, wherein said dump trailer means comprises: a trailer frame connectable to tromell unit frame; a rock box mounted to said trailer frame for receiving separated rock material from said transfer means;
said dump trailer box is manually tilted for dumping

10. A rock picker for collecting rock-soil mixture from the ground, separating said rocks from sting said rocks said soil, and collecting said rocks for disposal, comprising: rock picker of which each of said left and right windrows receiving rock-soil mixture from said windrows, to said collector comprising an hydraulically powered front elevator, tromell and rear elevator including a forward inlet end and an discharge end
